(19) United States
(12) Patent Application Publication
(10) Pub. No.: US 2010/0104166 A1
(43) Pub. Date: Apr. 29, 2010

(54) METHOD FOR PRODUCING A STEREOTACTIC IMAGE IN A MAMMOGRAPHY DEVICE

(75) Inventors: Michael Hall, Nurnberg (DE); Marc Hansroul, Montreal (CA); Katrin Johansson, Erlangen (DE); Thomas Mertelmeier, Erlangen (DE); Serge Savard, Montreal (CA)

Correspondence Address: SCHIFF HARDIN, LLP;PATENT DEPARTMENT, 233 S. Wacker Drive-Suite 6600, CHICAGO, IL, 60606-6473, US

(73) Assignee: SIEMENS AKTEINGELLSCHAFT, MUENCHEN (DE)

(21) Appl. No.: 12/593,508

(22) PCT Filed: Sep. 16, 2008
(86) PCT No.: PCT/EP08/62284

§ 371 Date: Sep. 28, 2009

(30) Foreign Application Priority Data
Dec. 20, 2007 (DE) 10-2007-061-594.O

(51) Int. Cl. G06K 9/00

(52) U.S. Cl. 382/132; 382/154

(57) ABSTRACT

In a method for producing a stereotactic image of a patient fixed in a mammography device for a biopsy, a computerized control and evaluation unit waits for a start signal to be given by an operator, and after receipt of the start signal, automatically implements the following steps. An x-ray apparatus of the mammography device is positioned in a first predetermined imaging position, and a first image of the patient is acquired with the x-ray apparatus in this position. The x-ray apparatus is then pivoted into a second imaging position, different from the first, and a second image of the patient is acquired at the second position. The first and second images are acquired to form a stereotactic image of the patient.

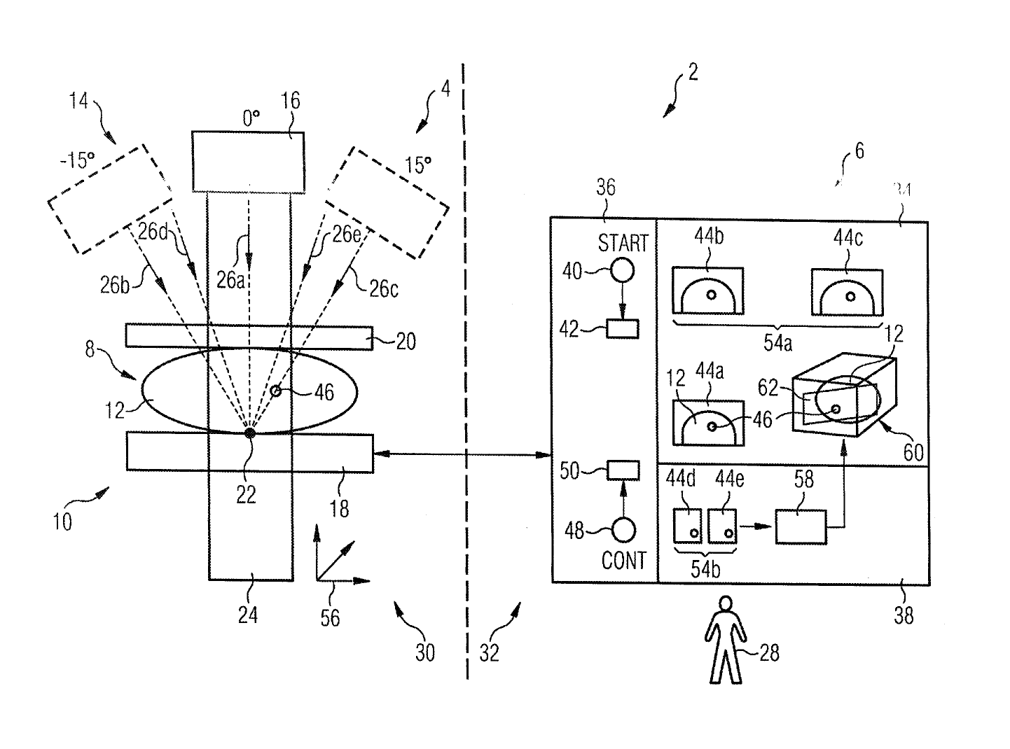

### BACKGROUND OF THE INVENTION

1. Field of the Invention

The present invention concerns a method to generate a stereotactic image of a patient fixed in a mammography system for a biopsy to be conducted on the patient.

2. Description of the Prior Art

Mammography systems normally serve for the x-ray examination of a breast of (typically) a female patient. If a suspicious point in the breast is diagnosed upon such an examination, a biopsy on the patient is also implemented with the aid of the mammography system, in which a biopsy needle is directed to the suspicious point in order to extract a tissue sample. In order to precisely hit the suspicious point with the biopsy needle, a localization of the suspicious point in the coordinate system of the mammography system is necessary.

For an image-assisted breast biopsy (also called a stereotactic biopsy), two x-ray images or mammograms are typically produced from slightly different viewing directions in order to enable the localization of the suspicious point that is the target of the biopsy. The two images are also called stereotactic images. The two viewing directions differ by, for example, +/−10° to +/−15° relative to the central diagnostic viewing direction, thus the viewing direction perpendicular from above along the longitudinal axis of the body of the patient through the breast (CC view). Often multiple pairs of stereotactic images are acquired in order to extract multiple tissue samples.

Today stereotactic images (thus two x-ray exposures) are acquired in the same manner as two conventional mammograms, namely as x-ray exposures of the patient. The workflow is follows. The patient in a treatment room is initially positioned in the CC view at the mammography system by an x-ray technician located there as an operator, and the breast is compressed or fixed in a compression device. After this the operator moves to the x-ray control room or an acquisition workstation and initiates the acquisition of an overview image or scout image in the central viewing direction (CC view). The operator subsequently again moves to the treatment room or to the mammography system and pans the x-ray head or the x-ray device manually to a first angle or first viewing direction, for example −15° relative to the CC view. The operator subsequently moves again to the control room or-to the workstation and initiates the acquisition of the first stereotactic image from this first viewing direction. The operator subsequently repeats the procedure for the second viewing direction or second stereotactic image, for example +15° relative to the CC view in order to complete the set of the stereotactic image.

The spatial position of the suspicious point is then determined in the coordinate system of the mammography system from the two exposures, and the biopsy needle is placed at the appropriate point. Given a placed biopsy needle, an additional pair of stereotactic images are subsequently acquired by the operator according to the above procedure in order the check whether the biopsy needle has actually (correctly) been placed at the suspicious point. The tissue sample is subsequently extracted. A third pair of stereotactic images is often subsequently acquired again by the operator according to the above procedure in order to check whether the tissue was actually removed at the corresponding point.

Each individual image of the stereotactic images must thus be separately acquired, and a manual operation or panning of the x-ray tube, a room change and a manual triggering of the x-ray radiation or x-ray device is necessary. This complete procedure described above is therefore extremely time-consuming.

During this entire, extremely time-consuming procedure, which is at the least uncomfortable if not actually very painful, the patient remains fixed in the compression device of the biopsy system. A movement of the patient with body displacement is very probable during this time, which in turn has negative effects on the spatial accuracy for the biopsy.

### SUMMARY OF THE INVENTION

An object of the invention is to improve the mammography or biopsy method by significantly reducing the time duration for the whole procedure. For example, this can be realized by a tightening of the workflow.

The invention is based on the insight that, from a technical standpoint, this tightening can be achieved by the acquisition time for stereotactic images being significantly reduced .

It is therefore also an object of the present invention to provide an improved method to generate stereotactic images of a patient fixed in a mammography system for a biopsy to be conducted on a patient.

The above object is achieved in accordance with the invention by method with the following steps implemented automatically by a control and evaluation unit. In a first method step, a start signal to be transmitted by the operator is waited for. The start signal serves to initiate a method at the end of which a stereotactic image should exist. The actual transmission of the signal by the operator therefore does not belong with the method according to the invention. Within the scope of the method according to the invention, the automatic, sequential implementation of the following steps is initiated after receiving the start signal. The x-ray device of the mammography system is first automatically positioned at a first, predeterminable acquisition position. “Predeterminable” means that the viewing direction or beam direction of the x-ray device (thus normally its pan angle relative to the CC view) can be predetermined at, for example, +15°. Within the scope of the invention, a first image of the patient is then produced from the first acquisition position with the x-ray device. The automatic panning of the x-ray device to a second predeterminable acquisition position different from the first acquisition position subsequently ensues. The acquisition of a second image of the patient from the second acquisition position with the x-ray device subsequently automatically ensues again. At this point, the automatic method is concluded and a stereotactic image exists in the mammography system in the form of the first and second image, which stereotactic image is provided for further use.

Conventional mammography systems are equipped with digital x-ray detectors whose cycle time—thus the minimum time between two successive x-ray acquisitions—is between 20 and 60 seconds. Since new x-ray detector generations that have a cycle time of, for example, less than 10 to 15 seconds are available today, two successive x-ray acquisitions can thus ensue within this short time. Because the displacement of the x-ray device and the triggering of the x-ray acquisitions ensue automatically, the minimum cycle time of the x-ray detectors can actually be used in the event of a panning of the x-ray system that takes place fast enough. For example, from the transmission of the start signal the panning of the x-ray source to the first acquisition position 5 requires 5 seconds, the acquisition of the first x-ray image with panning of the x-ray tube to the second acquisition position requires only 15 seconds; during this the x-ray detector has also already become ready to acquire a second x-ray image. The second x-ray image can thus already exist 20 seconds after transmission of the start signal. Given the known manual workflow, the procedure alone takes multiple minutes due to the paths which the operator must travel between x-ray protection room and mammography system.

The spatial position of the suspicious point is thus already known 20 seconds after the start of the procedure, and the biopsy can be implemented. The markedly reduced time for the acquisition of the stereotactic images has the effect that the patient normally moves significantly less during this time period and the localization accuracy for the suspicious point markedly increases, which increases the effectiveness of the entire biopsy procedure. The patient stress significantly decreases due to the severely shortened duration of the entire biopsy.

In an advantageous embodiment of the method, after receiving the start signal and before positioning the x-ray device in the first acquisition position the following additional steps can be automatically executed: the x-ray device is automatically brought into a predeterminable overview position from which an overview image exposure of the patient is automatically produced with the x-ray device and displayed to the operator. The automated procedure subsequently waits for a continuation signal of the operator.

The operator thus receives the possibility to stop the acquisition procedure, for example for the case that the patient is not correctly fixed at the mammography system, for example the suspicious point lies outside of the field of view of the x-ray device. In this case, the operator does not trigger a continuation signal, whereupon the method according to the invention is terminated. For example, the patient is then newly positioned at the mammography system before the method according to the invention is restarted.

If, within the method according to the invention, the continuation signal is received, the procedure as described above will continue with the automatic positioning of the x-ray device in the first predeterminable acquisition position.

In a further advantageous embodiment of the method, the method steps of positioning the x-ray device in the first acquisition position can be executed up to the acquisition of the second image of the patient as a multiple image sequence. Such a sequence is particular to the mammography system, i.e. belongs to its hard-set scope of services. Such a multiple image sequence is therefore a procedure specially tailored or, respectively, optimized for the respective mammography system, which procedure can thus be implemented particularly quickly and effectively. Within the scope of the method according to the invention, the corresponding sequence is thus merely initiated. The panning of the x-ray acquisition device or production of the x-ray images then proceeds in the mammography system in a time-optimized manner as an automatic, independent method.

In a further advantageous embodiment of the method, the steps “panning of the x-ray device to an acquisition position” and “production of an x-ray image” are respectively repeated for the acquisition of a predeterminable number of additional images from different predeterminable beam directions. In the course of the automatic method, an image data set composed of multiple individual images is thus generated of the patient. For example, this can be three to seven images. Via the production of multiple images, the spatial accuracy for the suspicious point is additionally increased so that the biopsy can be implemented even more precisely. The aforementioned initial scout exposure can also be integrated into such an image data set.

Multiple possibilities exist for the panning of the x-ray device between the different acquisition positions. For example, the x-ray device can respectively be panned in a time segment between two x-ray acquisitions (as before given a manual panning) and rest during the production of the x-ray exposures. In an alternative embodiment of the method, however, the panning of the x-ray device is not interrupted to acquire an image. The x-ray exposures are acquired “on the fly”, which again markedly reduces the total procedure time. For example, it is also possible to slow the movement of the x-ray device for the time period of the x-ray acquisition and to subsequently accelerate it again. An image correction to reduce movement artifacts can then ensue for such images acquired during the movement of the x-ray device, for example.

In a further advantageous embodiment of the method, the patient is protected from the movement of the x-ray device by a protective device, for example a head shield mounted at the mammography system. Patient and operator are thus unburdened of monitoring the automatic panning of the x-ray tube to avoid collision of the patient with moving parts of the mammography system.

In a further advantageous embodiment of the method, slice exposures are reconstructed from the images by means of a tomosynthesis method. This method variant is particularly suitable in embodiments of the invention in which more than two x-ray images of the patient are automatically acquired. In such a method variant, the typical advantages of a tomosynthetic or-quasi-tomosynthetic 3D image data set of the patient result for a stereotactic set of precisely two individual images.

### BRIEF DESCRIPTION OF THE DRAWING

The single FIGURE schematically illustrates a mammography system during a biopsy on a patient in accordance with the invention.

### DESCRIPTION OF THE PREFERRED EMBODIMENTS

The FIGURE shows a mammography system 2 that includes a mammography apparatus 4 in a treatment room 30 and a workstation 6 in a control room 32. Treatment room 30 and control room 32 are shielded from one another in terms of radiation (indicated by a dashed line). Especially in mammography it is also typical that treatment room 30 and control room 32 are a single room, wherein both regions (i.e. mammography apparatus 4 and workstation 6) are separated by a radiation protection wall.

A patient 8 (of whom only the breast 12 held in the compression device 10 is shown) is fixed in the mammography apparatus 4, i.e. in the compression device 10 thereof. The mammography device 4 also has an x-ray device 14. The x-ray device 14 has an x-ray source 16 and a flat panel detector 18. The flat panel detector 18, together with a compression plate 20, forms the compression device 10 to fix the breast 12. The x-ray device 14 or at least the x-ray source 16 thereof is supported on a stand 24 such that it can pivot on a pivot axis 22 running perpendicular to the image plane in the embodiment shown in the figure, but the pivot axis 22 is not required to lie in the detector plane as shown. In the position shown in the figure, the x-ray source 16 is located in the CC view position or 0° center position which allows a first perpendicular viewing direction 26a of the compressed breast 12.

The workstation 6 is a type known as an AWS (Acquisition Workstation). The entire mammography system 2 is controlled by an operator 28 via this. The workstation 6 has a monitor 34, a control panel 36 and a computer 38.

In the situation shown in the figure, the operator 28 has just fixed the patient 8 at the mammography apparatus 4 in the treatment room 30 and has now repaired to the control room 32. The mammography system 2 is in a prepared state or a wait state, therefore at the beginning of the method according to the invention. The operator 28 operates a start button 40 on the control panel 36 and thereby causes a start signal 42 in the workstation 6. In a first embodiment, the computer 38 that has waited for this start signal 42 initiates an automatic sequence of actions: the positioning of the x-ray source 16 in the shown 0° position ensues first at the mammography system 4 in the event that said x-ray source 16 is not already located in this position. The computer 38 then triggers an x-ray dose by the x-ray source 16, whereupon the flat panel detector 18 is exposed and a first exposure 44a in the form of a digital x-ray image is transmitted to the workstation 6, which displays this on the monitor 34 to the operator 28. The acquisition 44a is known as a scout image in which the operator 28 checks the correct positioning of the breast 12 in the compression device 10. A suspicious point 46 in the breast 12 which is to undergo a biopsy is also visible in the exposure 44a. The mammography system 2 is now again in a wait state, i.e. is inactive.

Since the operator 28 recognizes the positioning of the breast 12 to be correct using the exposure 44a, the operator activates a continuation button 48 and thereby triggers a continuation signal 50 in the workstation 6. In the basic form of the method according to the invention, the above steps are omitted and the procedure resumes at a more local point with the receipt of the start signal 42 instead of the continuation signal 50.

The computer 39 detects the continuation signal 50 and automatically executes all of the following steps. The x-ray source 16 is panned in the mammography apparatus 4 to the viewing direction 26b which is panned by −15° relative to the viewing direction 26a. The computer 38 subsequently triggers an additional x-ray dose in the x-ray source 16, whereupon the flat panel detector 18 transmits an additional x-ray image 44b (the first according to the invention) to the workstation 6, which displays this on the monitor 34. The computer 38 subsequently pans the x-ray source 16 to the viewing direction 26c which is panned by +15° relative to the viewing direction 26a. Here the computer 28 also automatically generates an additional x-ray image 44c (the second according to the invention) in the aforementioned manner. The x-ray images 44b and 44c together form a stereotactic image 54a. At this point the automatic generation of the stereotactic image 54 (and therefore the method according to the invention in its basic form) is concluded.

The stereotactic image 5a is subsequently evaluated by the computer 28 (in a known manner that need not be explained in detail herein) in order to determine the three-dimensional spatial position of the point 46 in the coordinate system 56 of the mammography apparatus 4. The operator was previously inactive except for the triggering of continuation signal 50 or start signal 42, i.e. was located in the control room 32. Now the operator 28 conducts the biopsy in the control room 32 or even initiates this automatically from the control room 32 without leaving it.

In an alternative variant of the method, the following additional intermediate steps are automatically executed in the method. After producing the first x-ray image 44b according to the invention, the computer 38 pans the x-ray source 16 in succession to the viewing directions 26d and 26e. There the computer 38 produces respective x-ray images 44d and 44e and transmits these to the computer 38 and/or displays these on the monitor 34. For example, a second stereotactic image 54b is thus created. Only then is the x-ray source 16 panned to the viewing direction 26c and does the method proceed as explained above. The second stereotactic image 54b is additionally used to locate the suspicious point 46.

In a further alternative embodiment, the movement of the x-ray source 16 at the viewing directions 26d and 26e is not stopped during the production of the exposures 44d and 44e. These are therefore produced “on the fly”. Alternatively, however, the movement is slowed during the production of the exposures in order to reduce movement artifacts.

Alternatively, all exposures 44a through 44e (thus including the scout image) can also be embodied in a tomography algorithm 58 to produce a 3D image data set 60 that is shown on the monitor 34 as a volume image. Arbitrary slice exposures 62 are then reconstructed from the image data set 60, which slice exposures 62 are likewise shown on the monitor 34. Moreover, the image data set 60 is also used to locate the suspicious point 46.

Although modifications and changes may be suggested by those skilled in the art, it is the intention of the inventors to embody within the patent warranted heron all changes and modifications as reasonably and properly come within the scope of their contribution to the art.

1. Method to generate a stereotactic image of a patient fixed in a mammography apparatus for a biopsy to be conducted on the patient, comprising the following steps implemented by a control and evaluation unit:
a) waiting for a start signal to be manually transmitted to the evaluation and control unit by an operator;
b) after receiving the start signal, automatically implementing of the steps:
c1) positioning of an x-ray device of the mammography apparatus in a first, predeterminable acquisition position;
c2) acquiring a first image of the patient with the x-ray device;
c3) panning the x-ray device to a second predeterminable acquisition position different from the first acquisition position;
c4) acquisition of acquiring a second image of the patient with the x-ray device; and
c5) combining and presenting the first image and the second image as a stereotactic image.

2. Method according to claim 1, comprising, before step c1),
automatically moving the x-ray device into a predeterminable overview position;
automatically acquiring an overview exposure of the patient with the x-ray device and presenting the overview image at a display for viewing by the operator;
waiting for a continuation signal from the operator
automatically proceeding with step c1) after receiving the continuation signal.

3. Method according to claim 1 comprising executing at least the steps c1) through c4) as a multiple image sequence unique to the mammography apparatus.

4. Method according to claim 1, comprising repeating steps c3) and c4) for acquisition of a predeterminable number of additional images respectively from different predeterminable acquisition positions.

5. Method according to panning without interruption the x-ray device to acquire an image in steps c2) and/or c4).

6. Method according to claim 1 comprising, with a protective device, automatically protecting the patient from collisions caused by the movement of the x-ray device.

7. Method according to claim 1, comprising reconstructing a slice exposure the images in a tomosynthesis algorithm.
